(19) United States
(12) Patent Application Publication
(10) Pub. No.: US 2006/0018221 A1
(43) Pub. Date: Jan. 26, 2006

(54) Optical information recording apparatus capable of optimizing laser power

(75) Inventor: Toshimasa Ito, Osaka (JP)

Correspondence Address: OSHA LIANG L.L.P., 1221 MCKINNEY STREET, SUITE 2800, HOUSTON, TX, 77010, US

(73) Assignee: Funai Electric Co., Ltd., Daito-shi (JP)

(21) Appl. No.: 11/183,433

(22) Filed: Jul. 18, 2005

(30) Foreign Application Priority Data
Jul. 23, 2004 (JP) 2004-215989

(51) Int. Cl. G11B 7/12

(52) U.S. Cl. 369/47.5; 369/47.53; 369/53.1

(57) ABSTRACT

In an optical information recording apparatus, information about the number of times of overwriting that is recorded on a recording medium is reproduced by a reproduction unit, and based on that number, one of prestored reference values of modulation factor is selected. Laser power that can achieve the selected reference value of modulation factor is determined to be the optimum laser power for use in a recording unit.

### BACKGROUND OF THE INVENTION

1. Field of the Invention

The present invention relates to an optical information recording apparatus, and more particularly to optimization of power of light when recording information on a recording medium in an optical information recording apparatus.

2. Description of the Background Art

There has conventionally been known a technique to optimize laser power for recording on an optically writable recording medium. In this technique, test recording is carried out by irradiating a prescribed portion of the recording medium, specifically a power calibration area (PCA) in the case of an optical disc, with light while changing laser power in a plurality of stages. The optimization of the laser power is performed based on quality evaluation of reproduction radio frequency (RF) signals obtained by reproducing the test-recorded information.

To evaluate the quality of the reproduction RF signal, a modulation factor m is normally used. The modulation factor m is a parameter that is calculated from a peak voltage A and a bottom voltage B of an envelop of the reproduction RF signal including a direct current (DC) component, in accordance with the following expression (1):
m=(A−B)/A. (1)

In the optical information recording apparatus, laser power with which a desired modulation factor m (reference modulation factor) is obtained is set as the optimum laser power, which is used for actual recording (writing of information).

Modulation factor m, used for determination of the laser power as described above, is sometimes set as a fixed value by each manufacturer of recording media. With such a fixed value, there may arise a problem that the optimum laser power cannot be determined corresponding to the state of a recording medium where information is actually recorded.

From this standpoint, Japanese Patent Laying-Open No. 2003-067925 discloses a technique to determine optimum laser power, wherein modulation factors are calculated from test recording carried out with different levels of laser power, and the optimum laser power is determined based on inclination of variation of the calculated modulation factors with respect to the laser power. The technique disclosed in Japanese Patent Laying-Open No. 2003-067925, however, may pose another problem that processing is complicated.

Based on the foregoing, Japanese Patent Laying-Open No. 2003-303416 discloses a technique to determine optimum laser power, wherein an optical disc is configured to have an area dedicated to reproduction in which an embossed part is formed in advance, and a modulation factor obtained by reproducing the embossed part is set as a target modulation factor.

However, with the technique disclosed in Japanese Patent Laying-Open No. 2003-303416, it is still hard to say that the laser power can be determined corresponding to the state of a recording medium where information is actually recorded, requiring further investigation.

### SUMMARY OF THE INVENTION

The present invention has been made to solve the above-described problems, and an object of the present invention is to provide an optical information recording apparatus that can determine laser power corresponding to a state of a recording medium where information is actually recorded.

An optical information recording apparatus according to an aspect of the present invention includes: a recording unit for recording information on a recording surface of a recording medium by irradiation of light beam by a laser; a reproduction unit for reproducing information recorded on a recording medium; a determination unit for determining optimum laser power for use in the recording unit by causing the recording unit to record prescribed information on a prescribed position of a recording medium and by performing quality evaluation of a reproduction signal reproduced by the reproduction unit for the prescribed information recorded on the prescribed position; and a storage unit for storing the numbers of times of overwriting of a recording medium in association with reference values of a modulation factor that is a ratio of amplitude of an alternating current component with respect to amplitude of a direct current component in the reproduction signal reproduced by the reproduction unit. In this apparatus, the determination unit determines the optimum laser power for the recording unit by causing the reproduction unit to reproduce information of the number of times of overwriting having been recorded on a recording medium, selecting one of the reference values of the modulation factor stored in the storage unit based on the number of times of overwriting recorded on the recording medium, and by setting laser power that can achieve the selected reference value of the modulation factor to be the optimum laser power.

An optical information recording apparatus according to another aspect of the present invention includes: a recording unit for recording information on a recording medium in the form of a disc by irradiation of light beam by a laser; a reproduction unit for reproducing information recorded on a recording medium; a determination unit for determining optimum laser power for use in the recording unit by causing the recording unit to record prescribed information on a prescribed position of a recording medium and by performing quality evaluation of a reproduction signal reproduced by the reproduction unit for the prescribed information recorded on the prescribed position; and a storage unit for storing locations in a radial direction of target recording areas on a recording medium in association with reference values of a modulation factor that is a ratio of amplitude of an alternating current component with respect to amplitude of a direct current component in the reproduction signal reproduced by the reproduction unit. In this apparatus, the determination unit determines the optimum laser power for the recording unit by selecting one of the reference values of the modulation factor stored in the storage unit based on a location in the radial direction of a target recording area on a recording medium and by setting laser power that can achieve the selected reference value of the modulation factor to be the optimum laser power.

An optical information recording apparatus according to yet another aspect of the present invention is an optical information recording apparatus that irradiates a recording surface of a disc-shaped recording medium with light beam to record information on and reproduce information recorded on the recording medium. The apparatus includes: a recording unit for recording information on a recording medium by irradiation of light beam by a laser; a reproduction unit for reproducing information recorded on a recording medium; a determination unit for determining optimum laser power for use in the recording unit by causing the recording unit to record prescribed information on a prescribed position of a recording medium and by performing quality evaluation of a reproduction signal reproduced by the reproduction unit for the prescribed information recorded on the prescribed position; and a storage unit for storing locations in a radial direction of target recording areas on a recording medium, the numbers of times of overwriting of a recording medium and information about manufacturers of recording media in association with reference values of a modulation factor that is a ratio of amplitude of an alternating current component with respect to amplitude of a direct current component in the reproduction signal reproduced by the reproduction unit. In this apparatus, the determination unit determines the optimum laser power for the recording unit by selecting one of the reference values of the modulation factor stored in the storage unit based on the number of times of overwriting that is obtained by causing the reproduction unit to reproduce information of the number of times of overwriting recorded on a recording medium, a location in the radial direction of a target recording area on the recording medium and the information about the manufacturer of the recording medium, and by setting laser power that can achieve the selected reference value of the modulation factor to be the optimum laser power.

According to the present invention, the modulation factor used by the optical information recording apparatus for determining laser power for use in recording information on a recording medium corresponds to the number of times of overwriting of the relevant recording medium.

As such, the optical information recording apparatus can set the laser power for use in recording information on a recording medium to correspond to the number of times of overwriting of the relevant recording medium, i.e., to correspond to the state of the recording medium where information is actually recorded.

Particularly, there conventionally was a case where the modulation factor for use in determination of laser power would be saturated as the number of times of overwriting of the recording medium increased. In contrast, according to the present invention, it is possible to avoid such saturation of the modulation factor.

Further, according to the present invention, the modulation factor used in the optical information recording apparatus for determination of laser power for use in recording information on a disc-shaped recording medium corresponds to a location in a radial direction of a target recording area on the recording medium.

As such, the optical information recording apparatus can set the laser power for use in recording information on the recording medium to correspond to the location of the target recording area on the recording medium, i.e., to correspond to the state of the recording medium where information is actually recorded.

Still further, according to the present invention, the laser power in the optical information recording apparatus can be determined in accordance with a manufacturer of the recording medium.

As described above, according to the present invention, the laser power is made to correspond to the state of a recording medium where information is actually recorded. Accordingly, it is possible to surely avoid failure in writing of information on a recording medium.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram of an embodiment of the optical information recording apparatus according to the present invention.

FIG. 2 schematically shows by way of example how reference values of the modulation factor are stored in a flash memory of the optical information recording apparatus of FIG. 1.

FIG. 3 is a flowchart of information recording processing carried out by a CPU of the optical information recording apparatus of FIG. 1.

FIGS. 4-9 schematically show how reference values of the modulation factor are stored in the flash memory of the optical information recording apparatus of FIG. 1.

### DESCRIPTION OF THE PREFERRED EMBODIMENTS

Hereinafter, an embodiment of the present invention will be explained with reference to the drawings.

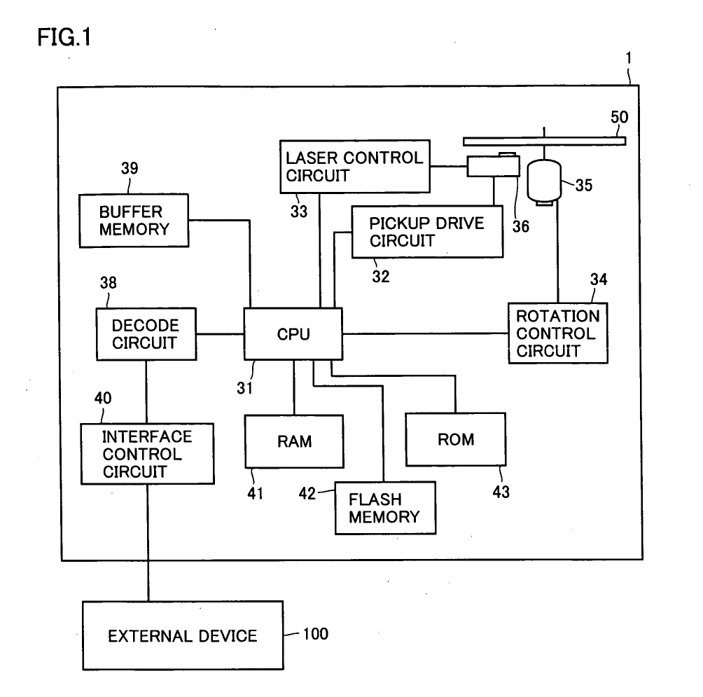

Referring to FIG. 1, an optical information recording apparatus 1 of an embodiment of the present invention includes a central processing unit (CPU) 31 that controls the entire operation of optical information recording apparatus 1. Optical information recording apparatus 1 further includes a pickup drive circuit 32, a laser control circuit 33, a rotation control circuit 34, a motor 35, a laser pickup 36, a decode circuit 38, a buffer memory 39, an interface control circuit 40, a random access memory (RAM) 41, a flash memory 42, and a read only memory (ROM) 43. Optical information recording apparatus 1 is connected to an external device 44 via interface control circuit 40.

When an optical disc 50 is set to optical information recording apparatus 1, motor 35 has its rotation controlled, and a spin-up operation is started. Here, rotation control circuit 34 carries out the rotation control of motor 35, as instructed by CPU 31. Laser pickup 36, driven by pickup drive circuit 32, reads data recorded on optical disc 50. Pickup drive circuit 32 drives laser pickup 36, as instructed by CPU 31.

The data read out of optical disc 50 is input to laser control circuit 33, where it is converted to an electric signal. The electric signal is sent from laser control circuit 33 to buffer memory 39 for storage.

RAM 41 has a part serving as a disc information storage portion.

CPU 31 reads management information, such as table of contents (TOC) and the like, out of the disc data received at buffer memory 39, and stores the management information in the disc information storage portion within RAM 41.

In the case where reading (or reproduction) of the information recorded on optical disc 50 is further conducted by a command from external device 100 or the like, the command is input to CPU 31. In response to the input of the command, CPU 31 instructs rotation control circuit 34 to rotate motor 35, and further instructs pickup drive circuit 32 to drive laser pickup 36, as in the above-described case. The data read by laser pickup 36 is temporarily stored in buffer memory 39, and then output via decode circuit 38 and interface control circuit 40 to external device 100.

CPU 31, based on the information input from external device 100, carries out writing and reading of information with respect to optical disc 50, in accordance with a control program stored in ROM 43.

Laser control circuit 33 controls laser irradiation by laser pickup 36, and also controls reading of information from the reflected light of the irradiated laser light. Rotation control circuit 34 controls the operation of motor 35.

In optical information recording apparatus 1, when information is to be recorded on optical disc 50 in accordance with a command from external device 100 or the like, CPU 31 outputs an instruction to rotation control circuit 34 to rotate motor 35, and further outputs an instruction to pickup drive circuit 32 to drive laser pickup 36.

When data to be recorded on optical disc 50 is transmitted from external device 100 to optical information recording apparatus 1, the data received is temporarily stored in buffer memory 39 before being recorded on optical disc 50.

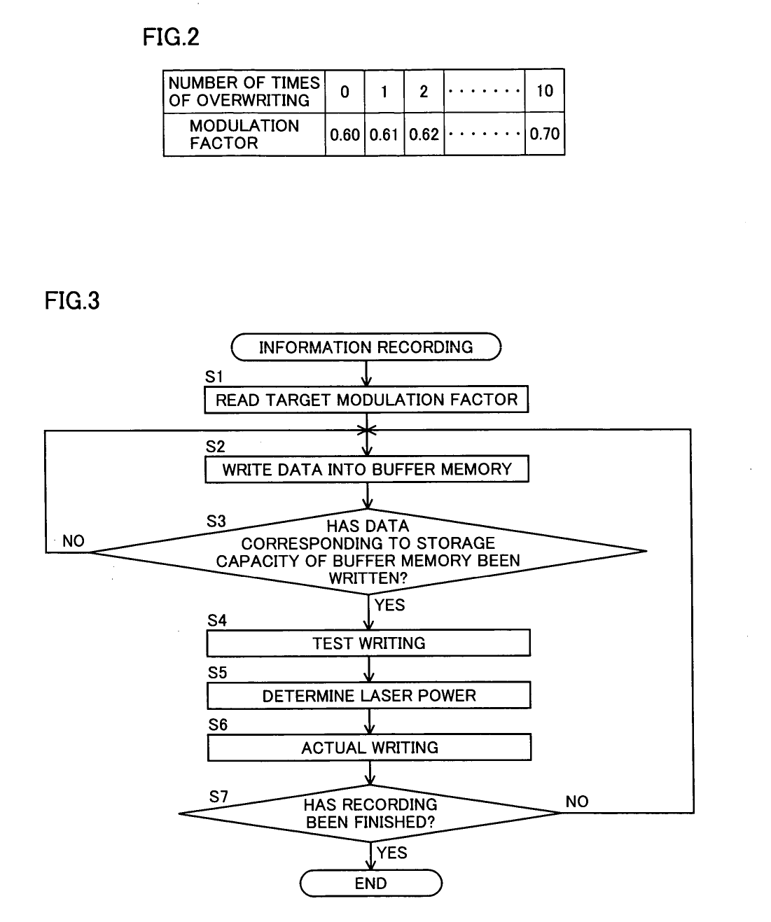

Flash memory 42 stores reference values of the modulation factor used for determination of laser power of laser pickup 36 (laser power used when laser pickup 36 records information (data) on optical disc 50). It is noted that the reference values of the modulation factor are stored in association with the number of times of overwriting on optical disc 50, as schematically shown in FIG. 2.

Hereinafter, referring to FIG. 3, an operation of optical information recording apparatus 1 in the case of recording data received from external device 100 onto optical disc 50 will be explained, including the contents related to determination of laser power as described above. FIG. 3 is a flowchart of the information recording processing carried out by CPU 31 in this case.

In the information recording processing, firstly, in step (hereinafter, “step” will not be repeated) S1, CPU 31 reads a reference value of modulation factor (target modulation factor) recorded on flash memory 42, as shown in FIG. 2, and stores the value in RAM 41. Specifically, in S1, CPU 31 refers to the number of times of overwriting of relevant optical disc 50 having been recorded on its lead-in area, and reads a target modulation factor corresponding to the relevant number of times of overwriting from flash memory 42 and stores the same in RAM 41.

Next, in S2, CPU 31 writes the data having been transmitted from external device 100 via interface control circuit 40 and decode circuit 38, to buffer memory 39.

In S3, CPU 31 determines whether information of an amount corresponding to the storage capacity of buffer memory 39 has been written into buffer memory 39. If so, CPU 31 proceeds to S4.

In S4, CPU 31 causes test writing to be carried out on the PCA of optical disc 50, while causing laser power of laser pickup 36 to be changed variously.

In S5, CPU 31 searches for laser power that can achieve the target modulation factor read in S2, based on reproduction signals of the data having been written during the test writing in the immediately preceding step S4, and determines the relevant laser power as optimum laser power for use in information recording by laser pickup 36.

In S6, CPU 31 causes the data written in buffer memory 39 to be recorded on an appropriate area of optical disc 50. In response to success in the data recording onto optical disc 50, the data having been written in buffer memory 39 is erased.

In S7, CPU 31 determines whether the recording of the data received from external device 100 onto optical disc 50 has been finished. If so, the information recording processing is completed. If it is determined that the recording has not yet been finished, CPU 31 returns to S2, receives the remaining data to be recorded on optical disc 50 successively from external device 100, and writes the data into buffer memory 39. That is to say, in the present embodiment, the optimum laser power of laser pickup 36 for recording data is determined every time the data of the amount corresponding to the storage capacity of buffer memory 39 is recorded on optical disc 50.

In the information recording processing described above, data is recorded onto optical disc 50 with the laser power corresponding to the number of times of data overwriting on the relevant optical disc 50.

It is preferable in the above-described information recording processing that the number of times of overwriting that is recorded in the lead-in area of optical disc 50 is incremented by 1 before the relevant information recording processing is finished.

Further, optical information recording apparatus 1 may determine the laser power for use in recording data on optical disc 50 in accordance with a location on optical disc 50 where data is to be recorded (also referred to as a “target recording area”), rather than the number of times of overwriting of optical disc 50. Here, the location of the target recording area on optical disc 50 refers, e.g., to a distance of the target recording area from the center of optical disc 50, which may also be referred to as a radial location of the relevant area of optical disc 50.

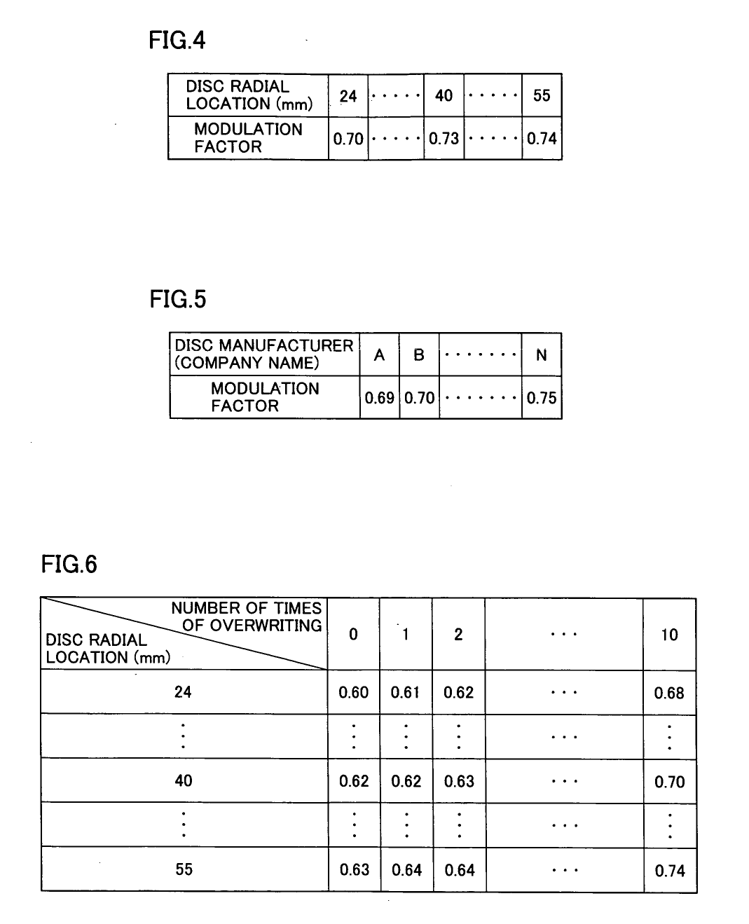

In such a case, flash memory 42 stores target modulation factors in association with the radial locations on optical disc 50 (DISC radial locations) as shown in FIG. 4, instead of storing the target modulation factors in association with the numbers of times of overwriting of optical disc 50 as shown in FIG. 2. In the information recording processing, in S1, the target modulation factors are written into RAM 41 for all the DISC radial locations shown in FIG. 4.

In determination of the optimum laser power in S5, CPU 31 detects the radial location of the area on optical disc 50 where data is to be written (recorded) in the next step S6, while moving laser pickup 36 to the inner-peripheral side of optical disc 50. CPU 31 then selects one of the target modulation factors written in RAM 41 that corresponds to the thus detected radial location, and sets the laser power that can achieve the selected target modulation factor to be the optimum laser power.

Alternatively, optical information recording apparatus 1 may determine the laser power for use in recording data on optical disc 50 in accordance with the manufacturer (company name or the like) of optical disc 50, instead of the number of times of overwriting of optical disc 50. In this case, flash memory 42 stores target modulation factors in association with the manufacturers of optical discs 50 (DISC manufacturers) as shown in FIG. 5, instead of storing the target modulation factors in association with the numbers of times of overwriting of optical disc 50 as shown in FIG. 2. It is noted that the information related to the manufacturer of optical disc 50 is recorded, e.g., in the lead-in area of each optical disc 50.

Still alternatively, optical information recording apparatus 1 may determine the optimum laser power of laser pickup 36 for use in recording based on two or all of the three conditions of: the number of times of overwriting of optical disc 50; the radial location of the target recording area on optical disc 50; and the manufacturer of optical disc 50.

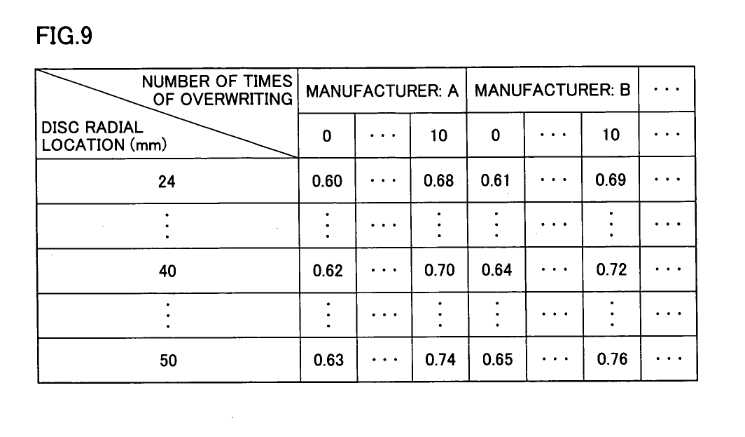

In such a case, flash memory 42 stores target modulation factors, either as shown in FIGS. 6-8 such that one target modulation factor can be determined uniquely based on any two of the three conditions of the number of times of overwriting of optical disc 50, the radial location of the target recording area on optical disc 50, and the manufacturer of optical disc 50, or as shown in FIG. 9 such that one target modulation factor can be determined uniquely based on all the three conditions.

FIG. 6 shows information stored in the case where the target modulation factor is determined based on the two conditions of the number of times of overwriting of optical disc 50 and the radial location on the disc. According to the information shown in FIG. 6, the target modulation factor is determined as 0.61 when the number of times of overwriting is “1” and the radial location is 24 mm.

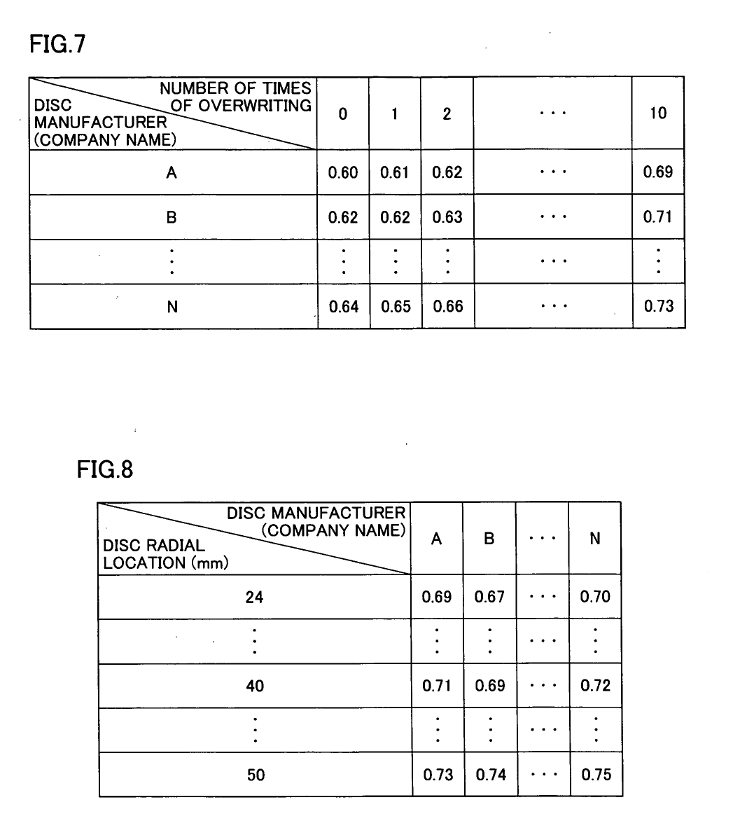

FIG. 7 shows information stored in the case where the target modulation factor is determined based on the two conditions of the number of times of overwriting and the manufacturer of optical disc 50. According to the information shown in FIG. 7, the target modulation factor is determined as 0.62 when the number of times of overwriting is “1” and the manufacturer is “B”.

FIG. 8 shows information stored in the case where the target modulation factor is determined based on the two conditions of the manufacturer of optical disc 50 and the radial location on the disc. According to the information shown in FIG. 8, the target modulation factor is determined as 0.69 when the manufacturer is “B” and the radial location is 40 mm.

FIG. 9 shows information stored in the case where the target modulation factor is determined based on the three conditions of the number of times of overwriting of optical disc 50, its manufacturer, and the radial location on the disc. According to the information shown in FIG. 9, the target modulation factor is determined to be 0.72 when the number of times of overwriting is “10”, the manufacturer is “B”, and the radial location is 40 mm.

Although an optical recording medium in the disc form has been explained in the above-described embodiment, the present invention is not restricted thereto. The optical recording medium may be in the form of a card, except the case where the above-described radial location is concerned.

Further, in the embodiment described above, when the target modulation factor is to be determined in accordance with the number of times of overwriting of optical disc 50, the number of times of overwriting may be divided into sections, and the target modulation factor may be determined for each section. For example, the number of times of overwriting may be divided into three sections of 1-10, 11-100, and 101 or more, and the target modulation factor may be set for each of the sections.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An optical information recording apparatus, comprising:
a recording unit for recording information on a recording surface of a recording medium by irradiation of light beam by a laser;
a reproduction unit for reproducing information recorded on a recording medium;
a determination unit for determining optimum laser power for use in said recording unit, by causing said recording unit to record prescribed information on a prescribed position of a recording medium, and by performing quality evaluation of a reproduction signal reproduced by said reproduction unit for said prescribed information recorded on said prescribed position; and
a storage unit for storing the numbers of times of overwriting of a recording medium in association with reference values of a modulation factor that is a ratio of amplitude of an alternating current component with respect to amplitude of a direct current component in the reproduction signal reproduced by said reproduction unit; wherein
said determination unit determines the optimum laser power for said recording unit by causing said reproduction unit to reproduce information of the number of times of overwriting having been recorded on a recording medium, selecting one of the reference values of said modulation factor stored in said storage unit based on the number of times of overwriting recorded on said recording medium, and by setting laser power that can achieve said selected reference value of said modulation factor to be the optimum laser power.

2. The optical information recording apparatus according to claim 1, wherein
said recording medium is in the form of a disc,
said storage unit stores the reference values of said modulation factor in association with the numbers of times of overwriting of a recording medium and locations in a radial direction of target recording areas on a recording medium, and
said determination unit selects one of the reference values of said modulation factor based on the number of times of overwriting recorded on said recording medium and the location in the radial direction of a target recording area on said recording medium.

3. The optical information recording apparatus according to claim 1, wherein
said storage unit stores the reference values of said modulation factor in association with the numbers of times of overwriting of a recording medium and information about manufacturers of recording media, and
said determination unit selects one of the reference values of said modulation factors based on the number of times of overwriting recorded on said recording medium and the information about the manufacturer of said recording medium.

4. An optical information recording apparatus, comprising:
a recording unit for recording information on a recording medium in the form of a disc by irradiation of light beam by a laser;
a reproduction unit for reproducing information recorded on a recording medium;
a determination unit for determining optimum laser power for use in said recording unit, by causing said recording unit to record prescribed information on a prescribed position of a recording medium, and by performing quality evaluation of a reproduction signal reproduced by said reproduction unit for said prescribed information recorded on said prescribed position; and
a storage unit for storing locations in a radial direction of target recording areas on a recording medium in association with reference values of a modulation factor that is a ratio of amplitude of an alternating current component with respect to amplitude of a direct current component in the reproduction signal reproduced by said reproduction unit; wherein
said determination unit determines the optimum laser power for said recording unit by selecting one of the reference values of said modulation factor stored in said storage unit based on a location in the radial direction of a target recording area on a recording medium and by setting laser power that can achieve said selected reference value of said modulation factor to be the optimum laser power.

5. The optical information recording apparatus according to claim 4, wherein
said storage unit stores the reference values of said modulation factor in association with the locations in the radial direction of the target recording areas on a recording medium and information about manufacturers of recording media, and
said determination unit selects one of the reference values of said modulation factor based on the location in the radial direction of a target recording area on said recording medium and the information about the manufacturer of said recording medium.
